(19) United States
(12) Patent Application Publication
(10) Pub. No.: US 2014/0279023 A1
(43) Pub. Date: Sep. 18, 2014

(54) METHOD FOR DATA COMMUNICATION IN A MOBILE TELEPHONE SYSTEM

(71) Applicant: WIFOG AB, Stockholm (SE)

(72) Inventor: Carl ANDER, Danderyd (SE)

(73) Assignee: Wifog AB, Stockholm (SE)

(21) Appl. No.: 13/799,260

(22) Filed: Mar. 13, 2013

(30) Foreign Application Priority Data
Mar. 13, 2013 (SE) 1350300-8

(51) Int. Cl. H04W 8/18

(52) U.S. Cl. CPC H04W 8/183
USPC 705/14.64; 455/432.1

(57) ABSTRACT

Method for data communication in a mobile telephone system with a mobile telephone (1) provided with a function via which data roaming can be switched off. When a user does not wish to use his or her operator with which the user has a subscription, called the first operator (2), the function via which data roaming can be switched off is activated, and a subscription for data communication only is caused to be set up with a second operator (3).

### FIELD OF THE INVENTION

The present invention refers to a method for data communication in a mobile telephone system.

### BACKGROUND OF THE INVENTION

As is well known a smart mobile telephone can be used for voice communication but also for transmitting data, such as data files and e-mails.

When a user having a subscription for a certain mobile telephone operator in a certain country moves to another country the mobile telephone will get connected to a local operator in that country which is called roaming.

From an administrative point of view issues like charging, subscription arrangements etc must be solved between the different operators.

From a technical point of view some topics are a consequence of the administrative matters, such as the transfer of call charges and the transfer of subscription information between the networks involved.

Operators apply different charges for speech services and data services, especially during roaming. This means that transmission of data becomes very expensive in case the user uses an operator in another country than in the country where the user has his/her subscription. This is mainly due to charges from the operator having the users subscription to the user.

A so called smart phone is therefore provided with a function by means of which data roaming can be switched off. If switched off there is no transfer of data between the network that is used and the smart phone. However, the speech service works irrespectively of if the data roaming is switched off or is turned on.

The present invention solves the problem of high charges when a user uses his/her smart phone for data transmission in a foreign country.

### SUMMARY OF THE INVENTION

The present invention thus refers to a method for data communication in a mobile telephone system with a mobile telephone (1) provided with a function by means of which data roaming can be switched off, and is characterized in, that when a user do not wish to use his or hers operator with which the user has a subscription, called the first operator (2), said function by means of which data roaming can be switched off is activated, and in that a subscription for data communication only is caused to be set up with a second operator (3).

### BRIEF DESCRIPTION OF THE DRAWINGS

The present invention is described below, partially in connection with an exemplifying embodiment shown in the drawing, where

FIG. 1 shows a schematic block diagram.

### DETAILED DESCRIPTION OF THE INVENTION

A very important embodiment of the present invention relates to when the user has entered a foreign country. Thereby the embodiment refers to a method for data communication in a mobile telephone system with a mobile telephone provided with a function by means of which data roaming can be switched off, and is charaterised in, that when a user has entered a foreign country, which is a country other than the home country where the user has a subscription with a first operator, said function by means of which data roaming can be switched off is activated, and in that a subscription for data communication only is caused to be set up with a second operator in the foreign country, which second operator provides speech service for the first operator.

Below the invention is described in a situation where the subscriber has entered a foreign country. However, the invention may be implemented in the same way if both the first and the second operator are in the same country, for example in the home country of the user.

The present invention thus refers to a method for data communication in a mobile telephone system with a mobile telephone 1. The telephone system may be a GSM system or a 3G or 4G system or any other suitable telephone communication system.

The mobile telephone 1 shall be provided with a function by means of which data roaming can be switched off.

When a user has entered a foreign country, that is a country other than the home country where the user has a subscription with a first operator 2, said function by means of which data roaming can be switched off is activated so that no data roaming occurs involving the first operator 2.

Thereafter a subscription for data communication only is caused to be set up with a second, local, operator 3 in the foreign country, which second operator 2 continues to provide speech service for the first operator 2.

This means that speech services is provided in a conventional way and the second operator 3 bills the first operator 2 for the speech services provided, as illustrated with the arrow 4, and the first operator 2 bills the user, as illustrated by the arrow 5.

However, the first operator 2 is not a part of data communication.

All telephone communication with the mobile telephone is thus carried out between the mobile telephone 1 and the second operator 3, as illustrated by the arrow 6. The Internet 7 is reached by the mobile telephone 1 via the second operator 3, as illustrated by the arrow 8.

The mobile telephone is provided with a function to be able to set up a subscription to the second operator for data communication even if the function to switch off data roaming is activated. Such a function can be provided in the software of the mobile telephone. An alternative is to download an application in the mobile telephone giving the function to set up a subscription to the second operator regarding data communication.

In a preferred embodiment said subscription for data communication is caused to be set up with the second operator 3 by means of that the user sends a Short Message Service (SMS) with the mobile telephone 1 to the second operator 3.

In an alternative preferred embodiment said subscription for data communication is caused to be set up with a second operator 3 by means of that the user sends an E-Mail with the mobile telephone 1 to the second operator 3.

Said SMS or E-Mail can be standardized. When the second operator 3 receives an SMS or an E-Mail the second operator 3 sends a request to the mobile telephone regarding the users name, billing address and possibly other data. It is also possible that the user, after having contacted the second operator 3, receives a PIN code or any other code that can be used when the user activates data communication with the second operator. The user may also install an application on the mobile telephone which handles the connection to the second operator as regards data communication.

According to another preferred embodiment the second operator 3 is caused to send advertisements to the users mobile telephone 1 instead of charging, or billing, the user. Hereby the user must look at the advertisement before the user gets access to data communication with the second operator 3. The advertisement can be short, for example up to 30 seconds. It can be local or global and it can relate to goods or services.

In case the user does not want to see the advertisements, or in case the second operator does not send any advertisements, the second operator charges, or bills, the user for data communication.

It is preferred that the data communication is caused to be done via the telecommunication network operated by the second operator 3.

Alternatively the data communication is caused to be done via a WIFI network operated by the second operator.

Thus, according to the present invention the costs for a user for data communication will be very much lower than the present costs when the user is abroad.

1. Method for data communication in a mobile telephone system with a mobile telephone (1) provided with a function by means of which data roaming can be switched off, characterised in, that when a user do not wish to use his or hers operator with which the user has a subscription, called the first operator (2), said function by means of which data roaming can be switched off is activated, and in that a subscription for data communication only is caused to be set up with a second operator (3).

2. Method according to claim 1, characterised in, that when a user has entered a foreign country, which is a country other than the home country where the user has a subscription with a first operator (2), said function by means of which data roaming can be switched off is activated, and in that a subscription for data communication only is caused to be set up with a second operator (3) in the foreign country, which second operator (3) provides speech service for the first operator (2).

3. Method according to claim 1, characterised in, that the mobile telephone is caused to set up a subscription to the second operator for data communication even if the function to switch off data roaming is activated.

4. Method according to claim 1, characterised in, that the second operator (3) is caused to send advertisements to the users mobile telephone (1) instead of charging the user.

5. Method according to claim 1, characterised in, that the second operator (3) charges the user for data communication.

6. Method according to claim 1, characterised in, that the data communication is caused to be done via a telecommunication network operated by the second operator (3).

7. Method according to claim 1, characterised in, that the data communication is caused to be done via a WIFI network operated by the second operator (3).

8. Method according to claim 4, characterised in, that the advertisements are in the form of a video message and/or a speech message.

9. Method according to claim 1, characterised in, that said subscription for data communication is caused to be set up with the second operator (3) by means of that the user sends a Short Message Service to the second operator (3).

10. Method according to claim 1, characterised in, that said subscription for data communication is caused to be set up with a second operator (3) by means of that the user sends an E-Mail to the second operator (3).

11. Method according to claim 2, characterised in, that the mobile telephone is caused to set up a subscription to the second operator for data communication even if the function to switch off data roaming is activated.

12. Method according to claim 2, characterised in, that the second operator (3) is caused to send advertisements to the users mobile telephone (1) instead of charging the user.

13. Method according to claim 2, characterised in, that the second operator (3) charges the user for data communication.

14. Method according to claim 2, characterised in, that the data communication is caused to be done via a telecommunication network operated by the second operator (3).

15. Method according to claim 2, characterised in, that the data communication is caused to be done via a WIFI network operated by the second operator (3).

16. Method according to claim 2, characterised in, that the advertisements are in the form of a video message and/or a speech message.

17. Method according to claim 2, characterised in, that said subscription for data communication is caused to be set up with the second operator (3) by means of that the user sends a Short Message Service to the second operator (3).

18. Method according to claim 2, characterised in, that said subscription for data communication is caused to be set up with a second operator (3) by means of that the user sends an E-Mail to the second operator (3).
